(19) United States
(12) Patent Application Publication
(10) Pub. No.: US 2012/0030007 A1
(43) Pub. Date: Feb. 2, 2012

(54) ONLINE ADVERTISEMENT PROFILES

(75) Inventor: Mingjiang Ye, Beijing (CN)

(73) Assignee: Yahoo Inc., Sunnyvale, CA (US)

(21) Appl. No.: 12/845,113

(22) Filed: Jul. 28, 2010

(51) Int. Cl. G06Q 30/00

(52) U.S. Cl. 705/14.42; 705/14.41; 705/14.43

(57) ABSTRACT

Techniques are provided in which information is obtained regarding a set of one or more online advertisements. Information is also obtained relating to performance of advertisements of the set, including information regarding locations of user recipients of the advertisements and information regarding times of serving or receipt of the advertisements. Using the obtained information, an advertisement profile is built, relating to the set of advertisements, providing an indication of varying advertisement performance in connection with differing times of serving or receipt, and differing locations of user recipients. The advertisement profile may be used in selection or ranking of advertisements.

### BACKGROUND

Various techniques are used in optimization of online advertising and advertising campaigns, and other related areas. Techniques used in, for example, optimizing advertisement selection, and matching of online advertisements in connection with serving opportunities, can lead to enhanced advertisement performance, greater profitability and return on investment for online advertisers, and a more efficient and optimized online advertising marketplace for all participants. Such techniques include, among other things, targeting techniques such as behavioral targeting, time-based targeted, and geotargeting.

However, there is a need for techniques for use in online advertising, including, for example, techniques for use in optimizing aspects of online advertising and online advertising campaigns.

### SUMMARY

Some embodiments of the invention provide systems and methods in which information is obtained regarding a set of one or more online advertisements. Information is also obtained relating to performance of advertisements of the set, including information regarding locations of user recipients of the advertisements and information regarding times of serving or receipt of the advertisements. Using the obtained information, an advertisement profile is built, relating to the set of advertisements, providing an indication of varying advertisement performance in connection with differing times of serving or receipt, and differing locations of user recipients. The advertisement profile may be used, for example, in optimization of online advertising or advertising campaigns, or in selection or ranking of advertisements, or for other purposes.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a flow diagram illustrating a method according to one embodiment of the invention; and

FIG. 6 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

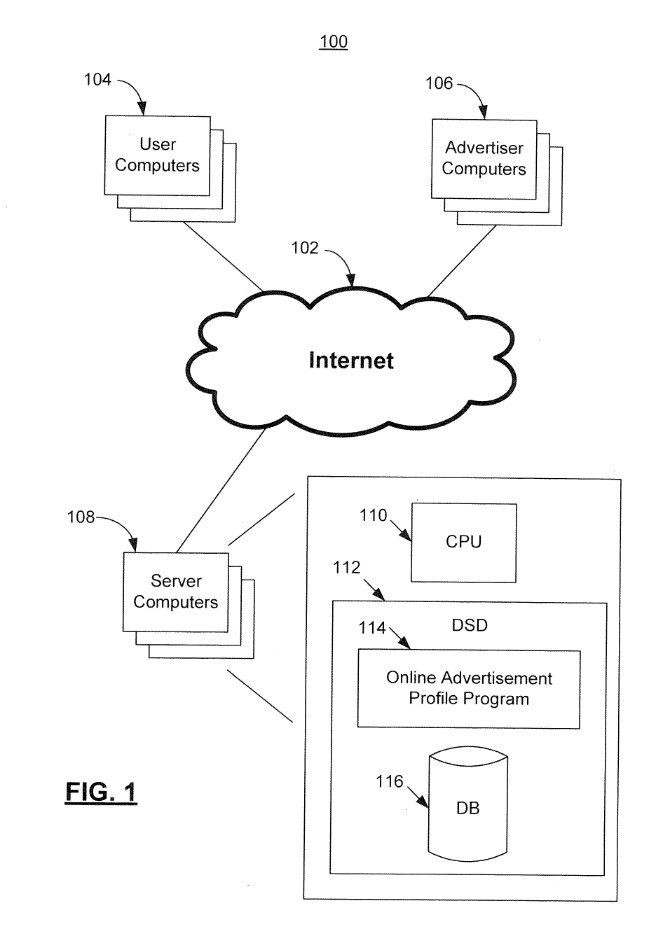

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and Online Advertisement Profile Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

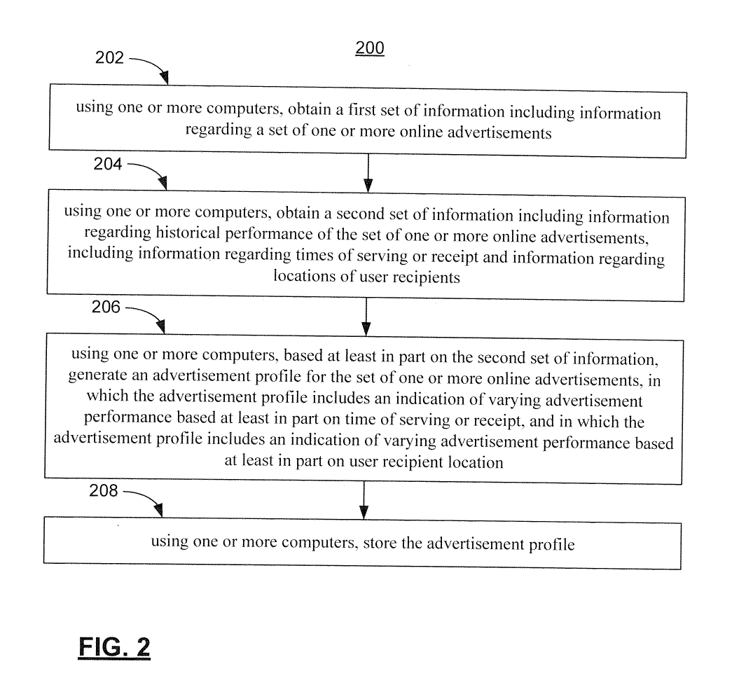

FIG. 2 is a flow diagram illustrating a method 200 according to one embodiment of the invention. At step 202, using one or more computers, a first set of information is obtained, including information regarding a set of one or more online advertisements.

At step 204, using one or more computers, a second set of information is obtained, including information regarding historical performance of the set of one or more online advertisements, including information regarding times of serving or receipt and information regarding locations of user recipients.

At step 206, using one or more computers, based at least in part on the second set of information, an advertisement profile is generated for the set of one or more online advertisements, in which the advertisement profile includes an indication of varying advertisement performance based at least in part on time of serving or receipt, and in which the advertisement profile includes an indication of varying advertisement performance based at least in part on user recipient location.

At step 208, using one or more computers, the advertisement profile is stored.

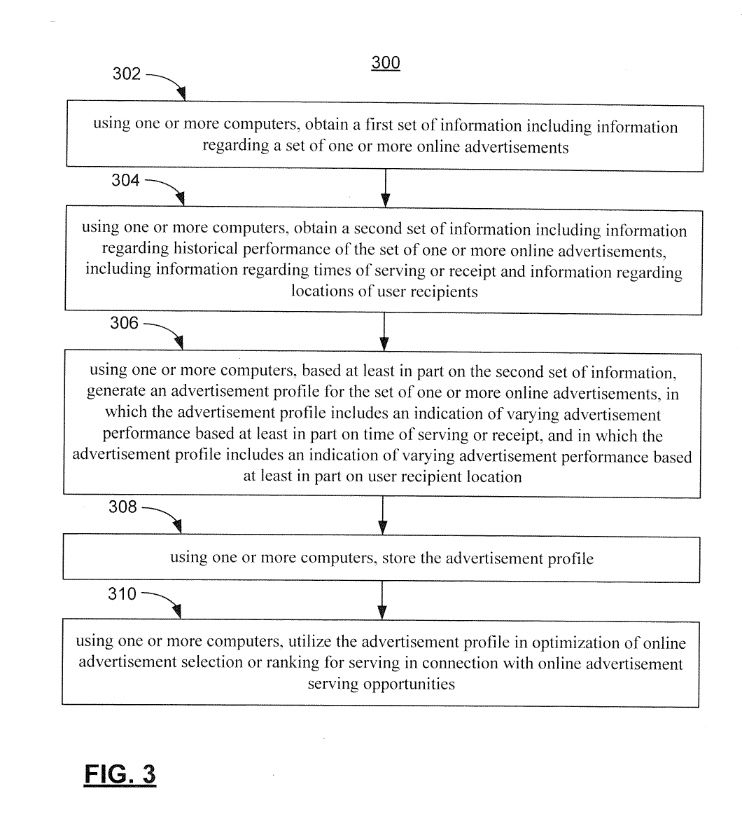

FIG. 3 is a flow diagram illustrating a method 300 according to one embodiment of the invention. Steps 302, 304, 306 and 308 are similar to steps 202, 204, 206 and 208 of the method 200 depicted in FIG. 2.

At step 310, using one or more computers, the advertisement profile is utilized in optimization of online advertisement selection and/or ranking for serving in connection with online advertisement serving opportunities.

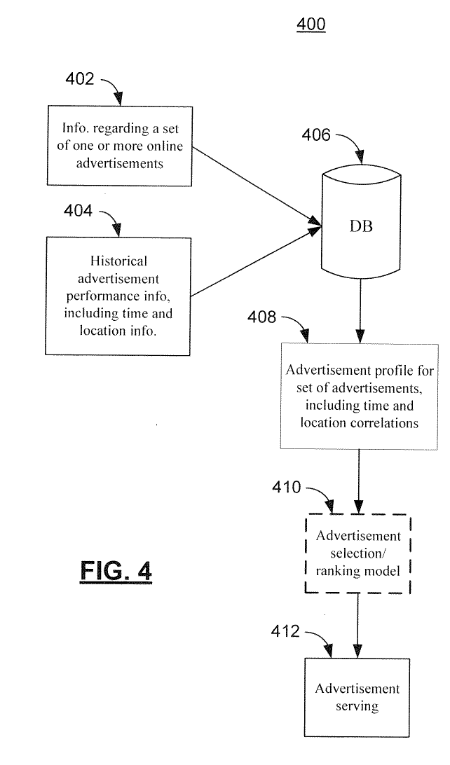

FIG. 4 is a flow diagram illustrating a method 400 according to one embodiment of the invention. As depicted, information is stored in a database 406, including information regarding a set of one or more online advertisements 402 and historical advertisement performance information including time and location information 404.

At step 408, the information 402, 404 is utilized in generating or building an advertisement profile relating to the set of one or more online advertisements, including time and location correlations with performance, such as differing performance levels associated with different time and location parameters.

At step 410, the advertisement profile, or information obtained from the advertisement profile, is utilized as input to an online advertisement selection and/or ranking model, which may select and rank advertisements for serving, such as sponsored search advertisements, ranked in terms of prominence or order of visual presentation, for example, in reply to a user search query.

At step 412, online advertisement serving takes place in accordance with the selection and ranking.

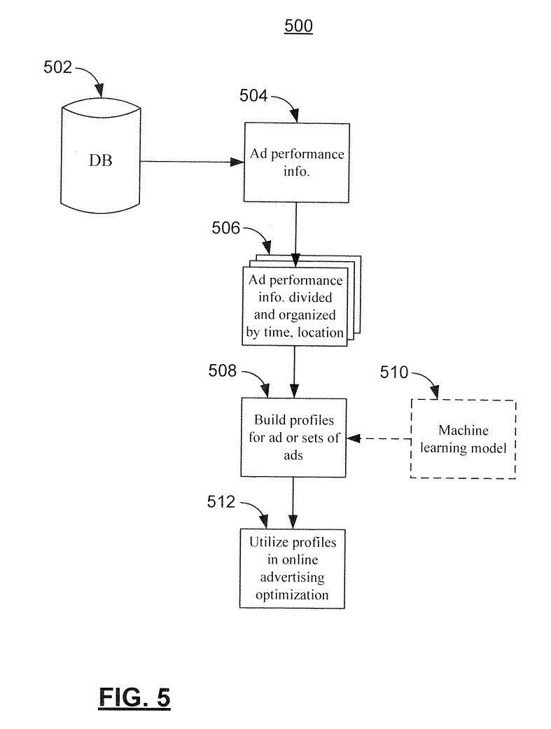

FIG. 5 is a flow diagram illustrating a method 500 according to one embodiment of the invention. The method 500 provides an example of aspects of advertisement profile building according to some embodiments of the invention.

At step 504, advertisement performance information, which can include historical information including click information, such as click through rate information, is obtained from a database 502.

At step 506, the advertisement performance information is divided and may be organized by time and location.

At step 508, utilizing the divided and organized advertisement performance information, profiles are built for sets of one or more advertisements.

For instance, as just a simple example, performance information may be organized by various geographical regions where the receiving user was located, and performance information may be aggregated for each region. Furthermore, performance information may be organized by time-related parameters, such as month of year, weekday or weekend, day of the week, hour or period of the day, special event period, etc., during which serving or receipt of an impression took place. Using this organized and aggregated information, advertisement profiles can be built for individual advertisements or sets of advertisements, such as sets of related advertisements. Each advertisement profile may include performance levels associated with different geographical areas, different time parameters, etc.

In some embodiments, a machine learning model 510 may be utilized in building advertisement profiles, or building some advertisement profiles. For example, in some embodiments, the model 510 may be used in determining or assessing advertisement performance levels for advertisements or sets of advertisements for which direct historical performance information is not available, or performance levels in connection with particular time, location or other parameters. For example, associations between features of advertisements and known historical performance information associated with those advertisements can be used to train the model 510, and the model 510 can then be used to assess performance levels for advertisements for which direct historical performance information is not available or is not sufficiently available, based at least in part on the features and associated performance levels.

At step 512, the advertisement profiles are used in online advertising optimization. This can broadly include online advertising planning and management by an advertiser, as well as other online advertising-related activities by various parties such as marketplace facilitators, marketmakers or publishers, etc.

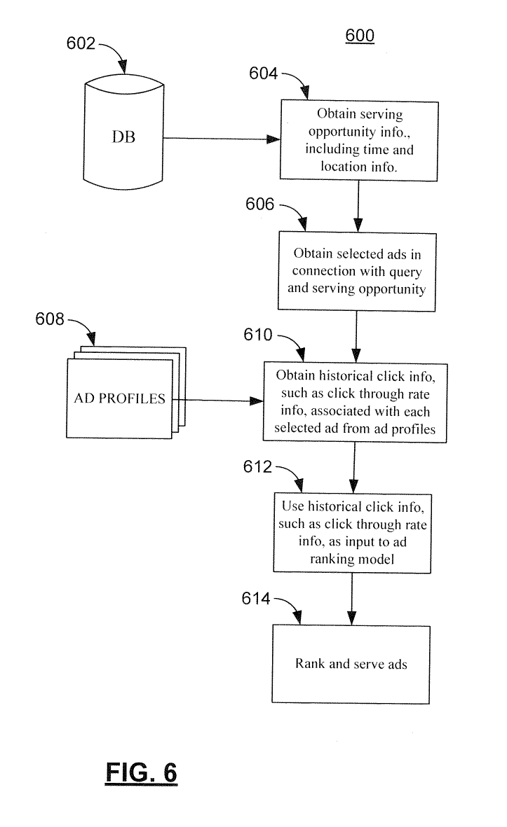

FIG. 6 is a flow diagram illustrating a method 600 according to one embodiment of the invention. The method 600 provides an example of aspects of advertisement selection, ranking and serving, according to some embodiments of the invention.

At step 604, serving opportunity information is obtained from a database 602, including time and location information associated with the serving opportunity.

At step 606, selected advertisements are obtained, or information regarding the selected advertisements is obtained, in connection with a user search query and associated serving opportunity. Of course, the advertisements may also be selected based in part on a wide variety of information and targeting or optimization parameters, including inventory management and availability parameters, campaign parameters, behavioral and user targeting parameters, geotargeting parameters, etc. In various embodiments, advertisement profiles may be used in advertisement selection and ranking, or may only be used in selection or ranking.

At step 610, historical click information, such as click through rate information, is obtained from advertisement profiles 608 associated with each selected advertisement. The historical click information can include various information that provides an indication of click through rates, ranges, or other measures of click through rate increase or decrease, for example, associated with different location and time parameters, for each advertisement (or set of advertisements).

At step 612, the historical click information, such as click through rate information, is used as input to an advertisement ranking model, such as a model that ranks sponsored search advertisements, for presentation to a user.

At step 614, advertisements are ranked in accordance with ranking determined using the model, and served.

Some embodiments of the invention include a recognition that known techniques for leveraging advertisement performance and parameters, such as in optimization advertisement selection, ranking, and serving, among other things, have not been optimized or ideal. For example, techniques exist in which advertisers may select geolocation or time-based parameters required for serving of particular advertisements or groups of advertisements. Also, targeting, selection or ranking can be performed based on categorization, user search queries, user profiles, including demographic or behavioral profiles, etc. Furthermore, advertisements can be targeted, selected or ranked based on a host of factors, including location and time-based factors, and techniques exist in which advertisers can, for example, specify such parameters for certain advertisements or advertisement groups.

Some embodiments of the invention provide, for example, a more optimal, sophisticated, flexible, and/or granular approach than previous techniques. For example, in some embodiments, individual advertisements or groups of advertisements are profiled. Such profiles can be sophisticated and granular, leveraging a wealth of historical performance information and associated circumstances and parameter information, and/or other information. For instance, very accurate and detailed tracking is possible today, so that advertisement performance can be tracked along with a host of associated parameters.

In some embodiments, time and location parameters are utilized, but some embodiments contemplate use of any number of other parameters that may be associated with advertisement serving or performance. This could broadly include, for example, a variety of contextual or circumstantial parameters, or other information or parameters directly or indirectly associated with advertisements or advertisement performance. For example, some parameters could be associated with the context of serving of an advertisement, such as the associated Web page, content of the page, etc., as well as parameters associated with search results, other advertisements, parameters associated with the user to whom the advertisement is presented, other users in a social network of the user, etc. Furthermore, other parameters could be associated with downstream performance and downstream context or circumstances associated with advertisements, such as context or circumstances when a user clicks on an advertisements, when a user makes a purchase associated with the advertisement, or other online or offline action or information, etc. Of course, many other examples are possible. While embodiments of the invention are described primarily with regard to advertisement profiles including time-based and location-based parameters, some embodiments of the invention contemplate profiles that include, incorporate or make user of any of a variety of other parameters instead or as well.

Embodiments of the invention contemplate various types of advertisement profiles. For example, in some embodiments, profiles may include a spectrum of values or ranges for a particular parameter, in association with a spectrum of performance levels or ranges associated, where each performance level or range may be associated with a particular parameter value or range. The advertisement profile may also include tables, indices or other data structures including such information. For example, time-related parameter values may include time of day, and each of a range of times can be associated with a level of performance, such as click through rate, based on historical performance information and/or other information. Where historical performance information is inadequate or lacking, performance information for similar advertisements, or similar parameter values, or both, may be used to approximate values for the advertisement or advertisements with which the profile is associated. Furthermore, in some embodiments, machine learning models or techniques may be used, in combination with advertisement features, for instance, in filling in gaps, etc., based on collected available performance information. Furthermore, in some embodiments, advertisement can have additional layers of complexity and sophistication such as mathematical or other models or constructs based at least in part on, or incorporating information as described above, which may aid in advertisement profile use, flexibility or efficiency.

In addition to the above, other more complex or granular advertisement profiles are contemplated. For example, some advertisement profiles may contain multidimensional associations, tables or other data structures, in which combinations of values or ranges for multiple parameters are associated with particular performance levels, based on available performance information. Furthermore, embodiments of the invention contemplate use of various types of information in addition to or other than performance information in advertisement profiles, or in building advertisement profiles.

Some embodiments of the invention contemplate advertisement profiles that not only include advertisement performance and parameter information and association information, but also include any of various other types of profile information, which can be any information relating to the advertisement or advertisements, or the character, nature, or associated circumstances or context therefore.

Some embodiments of the invention further contemplate advertisement profiles that include or make use of prediction or forecast information associated with advertisements, such as predicted or forecasted performance information.

As described, some embodiments of the invention include utilizing advertisement profiles in generating suggestions, recommendations, or automatic adjustments to advertisers or other parties regarding advertising campaigns, including targeting suggestions or budgetary suggestions, advertisement-associated bidding suggestions, or keyword selection or bidding suggestions, for example. As one simple example, if an advertisement profile indicates better performance on weekends, this information can be used in determining a suggestion to an advertiser to increase budget spend or bidding relating to that advertisement in connection with weekends.

Some embodiments of the invention further contemplate use of advertisement profiles in data mining and other information gathering, analysis, and usage efforts.

Some embodiments of the invention contemplate automated activities including automated advertisement profile building, automated advertisement campaign suggestions or actually implemented adjustments based on advertisement profiles, automated usage of profiles in marketplace operations including advertisement selection and ranking, etc. Furthermore, in some embodiments, advertisement profiles are updated or automatically updated based on newly available performance information or other information.

Embodiments of the invention contemplate usage of advertisement profiles in combination with other profiles, including, for example, user-associated profiles. Some embodiments further contemplate larger or broader profiles including advertisement profiles as well as other profiles, or integrated profiles including advertisement profile aspects as well as other aspects.

While the invention is described with reference to the above drawings, the drawings are intended to be illustrative, and the invention contemplates other embodiments within the spirit of the invention.

1. A method comprising:
using one or more computers, obtaining a first set of information comprising information regarding a set of one or more online advertisements;
using one or more computers, obtaining a second set of information comprising information regarding historical performance of the set of one or more online advertisements, including information regarding times of serving or receipt and information regarding locations of user recipients;
using one or more computers, based at least in part on the second set of information, generating an advertisement profile for the set of one or more online advertisements, wherein the advertisement profile includes an indication of varying advertisement performance based at least in part on time of serving or receipt, and wherein the advertisement profile includes an indication of varying advertisement performance based at least in part on user recipient location; and
using one or more computers, storing the advertisement profile.

2. The method of claim 1, comprising utilizing the advertisement profile in online advertising optimization or online advertising campaign optimization.

3. The method of claim 1, comprising utilizing the advertisement profile in optimization of online advertisement selection for serving in connection with online advertisement serving opportunities.

4. The method of claim 1, comprising utilizing the advertisement profile in or with a model for advertisement selection.

5. The method of claim 1, comprising utilizing the advertisement profile in sponsored search advertising.

6. The method of claim 1, comprising utilizing the advertisement profile in connection with one or more machine learning models.

7. The method of claim 1, comprising utilizing the advertisement profile in determining suggestions, proposals, or recommendations to make to online advertisers concerning aspects of online advertising campaigns.

8. The method of claim 1, comprising serving of an online advertisement, of the set of one or more online advertisements, selected based at least in part on the advertisement profile.

9. The method of claim 1, wherein obtaining the first set of information comprises obtaining information regarding the identity and subject or area of the set of one or more online advertisements.

10. The method of claim 1, wherein the set of one or more online advertisements consists of one online advertisement.

11. The method of claim 1, wherein the set of one or more online advertisements is a set of related advertisements.

12. The method of claim 1, wherein obtaining the second set of information comprises obtaining click through or conversion statistics in connection with times of serving or receipt and locations of user recipients.

13. The method of claim 1, wherein the advertisement profile provides an indication of historical advertisement performance in connection with different user recipient location parameters, and different time of serving or time of receipt parameters.

14. The method of claim 1, wherein generating the advertisement profile comprises:
obtaining association information associating advertisement performance-related events with time-based and location-based serving-related or impression-related parameters;
dividing the association information according to time-based and location-based parameters; and
determining and storing click through rate statistics according to time-based and location-based parameters.

15. The method of claim 1, comprising:
obtaining a time and user location associated with a serving opportunity, and obtaining a user search query associated with the serving opportunity;
selecting a set of candidate sponsored search advertisements for serving in connection with the serving opportunity, based at least in part on the user search query;
utilizing, from advertisement profiles associated with each of the candidate sponsored search advertisements, performance-related information for each of the candidate sponsored search advertisements, wherein the performance-related information is associated with the time and user location associated with the serving opportunity; and
utilizing the performance-related information as input to an advertisement ranking model used in ranking sponsored search advertisements in connection with the serving opportunity.

16. A system comprising:
one or more server computers coupled to a network; and
one or more databases coupled to the one or more server computers;
wherein the one or more server computers are for:
obtaining a first set of information comprising information regarding a set of one or more online advertisements;
obtaining a second set of information comprising information regarding historical performance of the set of one or more online advertisements, including information regarding times of serving or receipt and information regarding locations of user recipients;
based at least in part on the second set of information, generating an advertisement profile for the set of one or more online advertisements, wherein the advertisement profile includes an indication of varying advertisement performance based at least in part on time of serving or receipt, and wherein the advertisement profile includes an indication of varying of advertisement performance based at least in part on user recipient location; and
storing the advertisement profile in at least one of the one or more databases.

17. The system of claim 16, comprising utilizing the advertisement profile in online advertising optimization or online advertising campaign optimization.

18. The system of claim 16, comprising utilizing the advertisement profile in optimization of online advertisement selection for serving in connection with online advertisement serving opportunities.

19. The system of claim 17, comprising serving of an online advertisement, of the set of one or more online advertisements, selected based at least in part on the advertisement profile.

20. A computer readable medium or media containing instructions for executing a method comprising:
using one or more computers, obtaining a first set of information comprising information regarding a set of one or more online advertisements;
using one or more computers, obtaining a second set of information comprising information regarding historical performance of the set of one or more online advertisements, including information regarding times of serving or receipt and information regarding locations of user recipients;
using one or more computers, based at least in part on the second set of information, generating an advertisement profile for the set of one or more online advertisements, wherein the advertisement profile includes an indication of varying advertisement performance based at least in part on time of serving or receipt, and wherein the advertisement profile includes an indication of varying advertisement performance based at least in part on user recipient location;
using one or more computers, storing the advertisement profile; and
using one or more computers, utilizing the advertisement profile in optimization of online advertisement selection or ranking for serving in connection with online advertisement serving opportunities.
